(19) United States
(12) Patent Application Publication
(10) Pub. No.: US 2017/0178213 A1
(43) Pub. Date: Jun. 22, 2017

(54) METHOD, SYSTEM, AND DEVICE FOR PROVIDING ITEM INFORMATION

(71) Applicant: Alibaba Group Holding Limited, Grand Cayman (KY)

(72) Inventors: Xu Wang, Hangzhou (CN); Wei Zhao, Hangzhou (CN)

(21) Appl. No.: 15/373,300

(22) Filed: Dec. 8, 2016

(30) Foreign Application Priority Data
Dec. 16, 2015 (CN) 201510944630.9

(51) Int. Cl. G06Q 30/06

(52) U.S. Cl. CPC G06Q 30/0623; G06Q 30/0641

(57) ABSTRACT

A method for providing item information is disclosed. The method may comprise providing an item webpage. The webpage may comprise digest information of at least one item, the digest information may comprise a representative picture of the item, the item may be associated with a corresponding attribute list, and the attribute list may comprise attributes of the associated item in multiple dimensions and corresponding attribute values. The method may further comprise, in response to a first operation executed on the representative picture, switching at least a part of contents presented at a position of the representative picture to the associated attribute list.

### CROSS REFERENCE TO RELATED APPLICATION

The present application is based on and claims the benefit of priority to Chinese Application No. 201510944630.9, filed Dec. 16, 2015, the entire contents of which are incorporated herein by reference.

### TECHNICAL FIELD

The present disclosure relates generally to information processing technologies, and more particularly, to methods, systems, and devices for providing item information.

### BACKGROUND

In an e-commerce transaction platform system, a merchant or vendor (referred to as a first user) can offer various items (e.g., products, goods, and services) for sale on the platform, and provide detailed information of the items such as product pictures and descriptions. Correspondingly, a buyer or consumer (referred to as a second user) can browse the information of the issued items on a client terminal.

Generally, the second user browses the information of the items in the following manner: entering a list page comprising a certain category of items by clicking through links (including sales promotion entry, theme entry, and store entry links) presented on the home page of the client terminal; or typing keywords of a specific item or keywords of a specific store through a search entry provided on the home page to enter a list page of search results or items in the store. Multiple information presentation positions (commonly known as “pits”) are usually provided on the above list pages, and general information of an item is presented in each information presentation position. The general information usually includes a representative picture of the item, and may also include brief text description information such as price and quantity. The second user may obtain, from the general information, a primary impression and understanding of each item on the list page. If the second user is interested in a certain item, the second user may click the pit where the item is located to trigger presentation of a detailed page of the item. The second user can learn about more detailed information from the detailed page of the item such as more pictures and more text descriptions, and the more detailed information can further assist the second user to make a purchase decision.

However, in the actual application, the following situation usually occurs: the second user may trigger the opening of detailed pages of multiple items in a browsing process and may finally purchase one or a few of the items. That is, many detailed pages may be opened and closed before a transaction is made, and because each detailed page contains numerous information like pictures, the loading, rendering and other processing on the page may require a great amount of system resources. A lot of resources are wasted in the browsing process.

### SUMMARY

One aspect of the present disclosure is directed to a method for providing item information. The method may comprise providing a webpage. The webpage may comprise digest information of at least one item, the digest information may comprise a representative picture of the item, the item may be associated with a corresponding attribute list, and the attribute list may comprise attributes of the associated item in multiple dimensions and corresponding attribute values. The method may further comprise, in response to a first operation executed on the representative picture, switching at least a part of contents presented at a position of the representative picture to the associated attribute list.

Another aspect of the present disclosure is directed to a method for providing item information. The method may comprise receiving, by a server from a client terminal, a request for presenting a webpage, and providing page data of the webpage. The page data may comprise digest information of at least one item, the digest information may comprise a representative picture of the item, the item may be associated with a corresponding attribute list, the attribute list may comprise attributes of the corresponding item in multiple dimensions and corresponding attribute values, and the webpage may be presented on the client terminal. The method may further comprise, in response to a first operation executed on a representative picture of a target item of the at least one item on the webpage, switching at least a part of contents presented at the position of the representative picture to the associated attribute list.

Another aspect of the present disclosure is directed to a method for providing item information. The method may comprise receiving, by a client terminal, page data provided by a server. The page data may comprise digest information of at least one item, the digest information may comprise a representative picture of the item, the item may be associated with a corresponding attribute list, and the attribute list may comprise attributes of the associated item in multiple dimensions and corresponding attribute values. The method may further comprise presenting a webpage according to the page data, and in response to a first operation executed on a representative picture of a target item of the at least one item on the webpage, switching at least a part of contents presented at the position of the representative picture to the associated attribute list.

Another aspect of the present disclosure is directed to a method for determining an attribute list of an item. The method may comprise determining a degree of attention paid by a second user to each attribute dimension, adding an attribute dimension and a corresponding attribute value into an attribute list, if the degree of attention paid by the second user to the attribute dimension satisfies a preset condition, and associating the attribute list with the item.

Another aspect of the present disclosure is directed to a method for determining an attribute list of an item. The method may comprise determining a degree of attention paid by a second user to an attribute dimension of an item in a category, determining the attribute dimension, to which the degree of attention paid by the second user satisfies a preset condition, as a target attribute dimension of the item in the category, determining an attribute value of the item in the target attribute dimension, adding the target attribute dimension and the corresponding attribute value into an attribute list, and associating the attribute list with the item.

Another aspect of the present disclosure is directed to an apparatus for providing item information. The apparatus may comprise a page providing unit configured to provide a webpage. The webpage may comprise digest information of at least one item, the digest information may comprise a representative picture of the item, the item may be associated with a corresponding attribute list, and the attribute list may comprise attributes of the associated item in multiple dimensions and corresponding attribute values. The apparatus may further comprise a content switching unit configured to, in response to a first operation executed on the representative picture, switch at least a part of contents presented at a position of the representative picture to the associated attribute list.

Another aspect of the present disclosure is directed to an apparatus for providing item information. The apparatus may be a server. The apparatus may comprise a request receiving unit configured to receive, from a client terminal, a request for presenting a webpage, and a page data providing unit configured to provide page data of the webpage. The page data may comprise digest information of at least one item, the digest information may comprise a representative picture of the item, the item may be associated with a corresponding attribute list, the attribute list may comprise attributes of the corresponding item in multiple dimensions and corresponding attribute values, and the webpage may be presented on the client terminal. The page data providing unit may be further configured to, in response to a first operation executed on a representative picture of a target item of the at least one item on the webpage, switch at least a part of contents presented at the position of the representative picture to the associated attribute list.

Another aspect of the present disclosure is directed to an apparatus for providing item information. The apparatus may be a client terminal. The apparatus may comprise a page data receiving unit configured to receive page data provided by a server. The page data may comprise digest information of at least one item, the digest information may comprise a representative picture of the item, the item may be associated with a corresponding attribute list, and the attribute list may comprise attributes of the associated item in multiple dimensions and corresponding attribute values. The apparatus may further comprise a page presenting unit configured to present a webpage according to the page data, and a content switching unit configured to, in response to a first operation executed on a representative picture of a target item of the at least one item on the webpage, switch at least a part of contents presented at the position of the representative picture to the associated attribute list.

Another aspect of the present disclosure is directed to an apparatus for determining an attribute list of an item. The apparatus may comprise a first degree of attention determining unit configured to determine a degree of attention paid by a second user to each attribute dimension, a first attribute list generating unit configured to add an attribute dimension and a corresponding attribute value into an attribute list, if the degree of attention paid by the second user to the attribute dimension satisfies a preset condition, and a synthesizing unit configured to associate the attribute list with the item.

Another aspect of the present disclosure is directed to an apparatus for determining an attribute list of an item. The apparatus may comprise a second degree of attention determining unit configured to determine a degree of attention paid by a second user to an attribute dimension of an item in a category, a target dimension determining unit configured to determine the attribute dimension, to which the degree of attention paid by the second user satisfies a preset condition, as a target attribute dimension of the item in the category, a second attribute list generating unit configured to determine an attribute value of the item in the target attribute dimension, and add the target attribute dimension and the corresponding attribute value into an attribute list, and a second associating unit configured to associate the attribute list with the item.

Another aspect of the present disclosure is directed to a non-transitory computer-readable storage media storing instructions that, when executed by a processor, cause the processor to perform a method for providing item information. The method may comprise providing a webpage. The webpage may comprise digest information of at least one item, the digest information may comprise a representative picture of the item, the item may be associated with a corresponding attribute list, and the attribute list may comprise attributes of the associated item in multiple dimensions and corresponding attribute values. The method may further comprise, in response to a first operation executed on the representative picture, switching at least a part of contents presented at a position of the representative picture to the associated attribute list.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a flow chart illustrating a first method for providing item information, consistent with exemplary embodiments of the present disclosure.

FIGS. 2A to 2D are schematic diagrams illustrating user interfaces, consistent with exemplary embodiments of the present disclosure.

FIG. 3 is a flow chart illustrating a second method for providing item information, consistent with exemplary embodiments of the present disclosure.

FIGS. 4A to 4D are schematic diagrams illustrating user interfaces for providing item information, consistent with exemplary embodiments of the present disclosure.

FIG. 5 is a flow chart illustrating a third method for providing item information, consistent with exemplary embodiments of the present disclosure.

FIG. 6 is a flow chart illustrating a fourth method for providing item information, consistent with exemplary embodiments of the present disclosure.

FIG. 7 is a flow chart illustrating a fifth method for providing item information, consistent with exemplary embodiments of the present disclosure.

FIG. 8 is a block diagram illustrating a first apparatus for providing item information, consistent with exemplary embodiments of the present disclosure.

FIG. 9 is a block diagram illustrating a second apparatus for providing item information, consistent with exemplary embodiments of the present disclosure.

FIG. 10 is a block diagram illustrating a third apparatus for providing item information, consistent with exemplary embodiments of the present disclosure.

FIG. 11 is a block diagram illustrating a fourth apparatus for providing item information, consistent with exemplary embodiments of the present disclosure.

FIG. 12 is a block diagram illustrating a fifth apparatus for providing item information, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

In the embodiments of the present disclosure, to improve the browsing efficiency with respect to item information and to conserve system resources, a part of attribute information of one or more items may be presented in an item list page. For example, digest information of multiple items can be presented in the item list page. A second user can trigger a request for viewing an attribute list of the specified item in a predetermined operation manner (for example, pressing and holding or double clicking an information presentation position of the specified item). Correspondingly, the system can directly present the attribute list of the item at the position of the digest information of the item in the current list page. The content of the attribute list may be richer as compared with the digest information originally presented on the list page, for example, may include some specification parameters, and the content of the attribute list is more simplified as compared with a detailed page of the item. In this way, the second user can view, on the list page, richer attribute item information that the second user is interested in. If the digest information and the information of the attribute list both satisfy the requirement of the second user, the second user may open the detailed page; and if the digest item information satisfies the requirement of the second user while the attribute list of the item does not, the second user may decide not to open the detailed page of the item. Therefore, the second user may not need to open the detailed page of an item in order to make a purchase decision, and items that do not satisfy the requirement can be determined from the attribute lists and filtered out. The browsing efficiency of the second user can be improved, and because the number of detailed pages that need to be opened is reduced, the system resources can be conserved.

The items in this disclosure may include products, goods, services, tickets, or the like. Such items may be offered online for viewing, sale, or other purposes. The page in this disclosure may refer to a webpage, and the webpage may be presented by a computer, a cellphone, a software, an application, or the like.

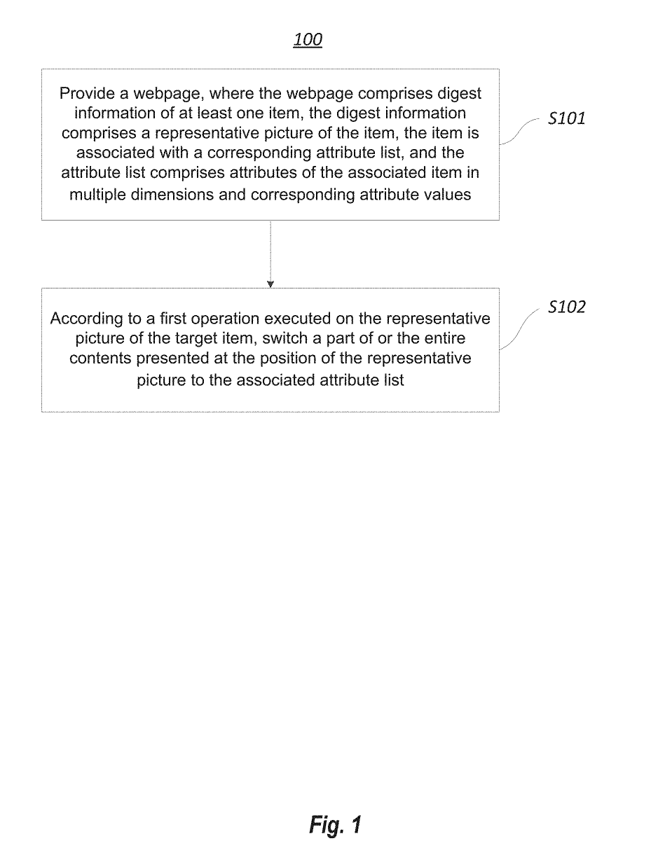

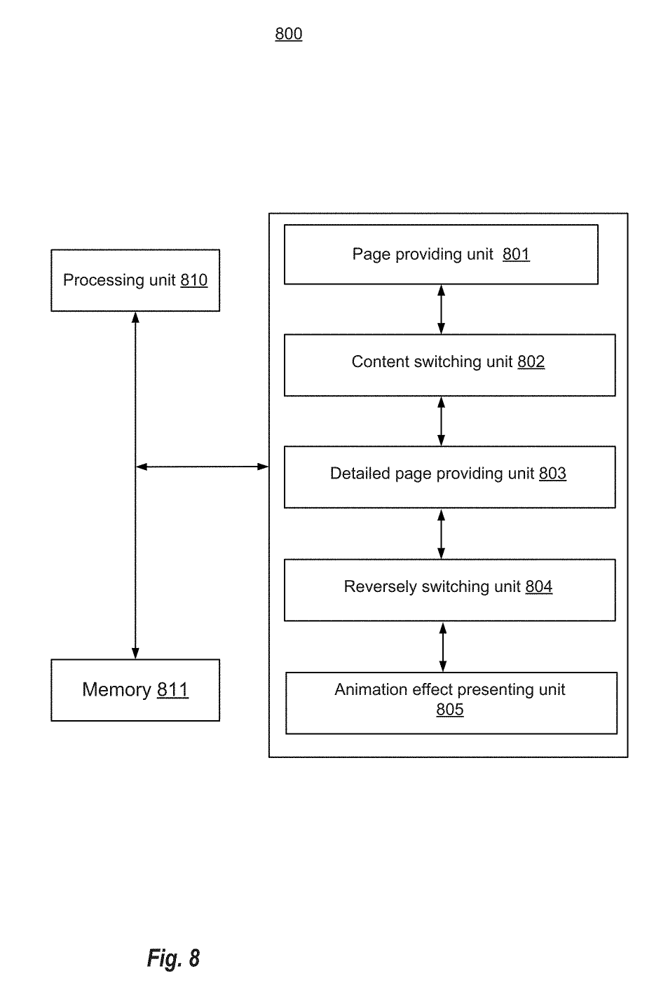

FIG. 1 is a flow diagram illustrating a method 100 for providing item information, consistent with exemplary embodiments of the present disclosure. The method may be implemented by a specialized server, e.g., apparatus 800 described below with reference to FIG. 8. Method 100 may include the following steps, some of which may be optional.

S101: Provide a webpage, where the webpage includes digest information of at least one item, the digest information includes a representative picture of the item, the item is associated with a corresponding attribute list, and the attribute list includes attributes of the associated item in multiple dimensions and corresponding attribute values.

In some embodiments, the page may be an item list page including at least one information presentation position (commonly known as “pit”). Each information presentation position may be used for presenting the digest item information. The digest information may include a representative picture, and text description information, for example, main text description such as title and price of the item. Further, each item may be associated with an attribute list, and the attribute list may present attributes of the item in multiple dimensions and attribute values thereof.

S102: In response to a first operation executed on the representative picture of the target item, switch a part of or the entire contents presented at the position of the representative picture to the associated attribute list.

In some embodiments, S102 may include receiving a first operation executed on the representative picture, and according to the received first operation, switching at least a part of contents presented at a position of the representative picture to the associated attribute list.

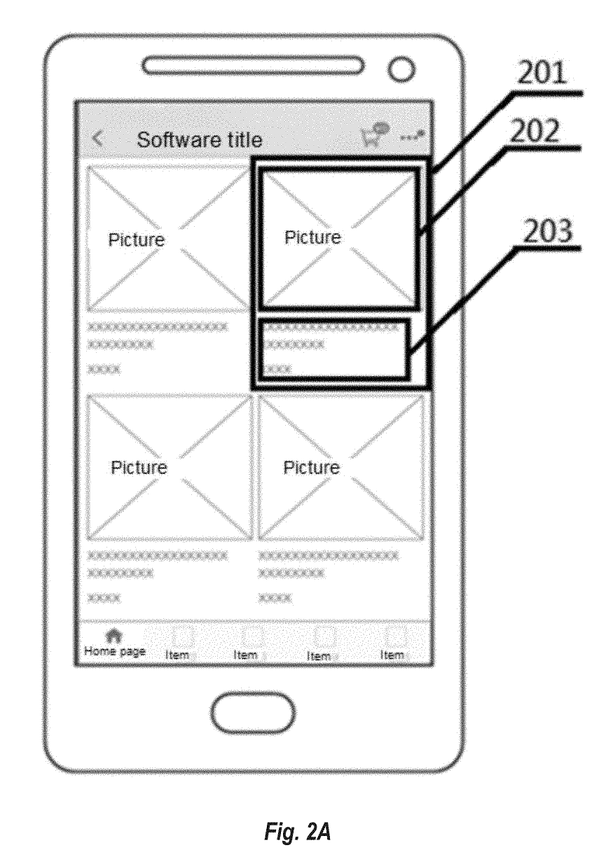

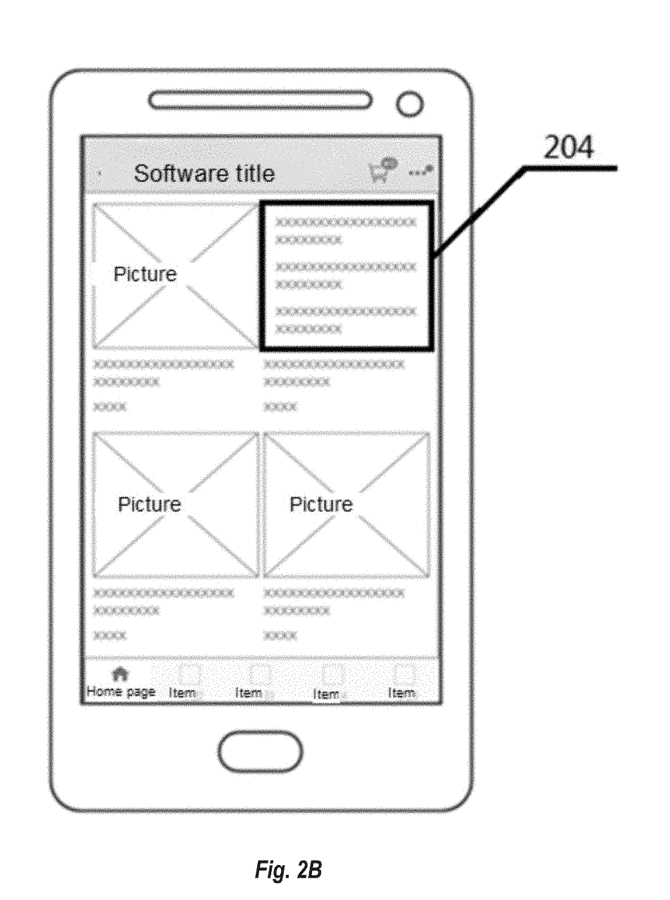

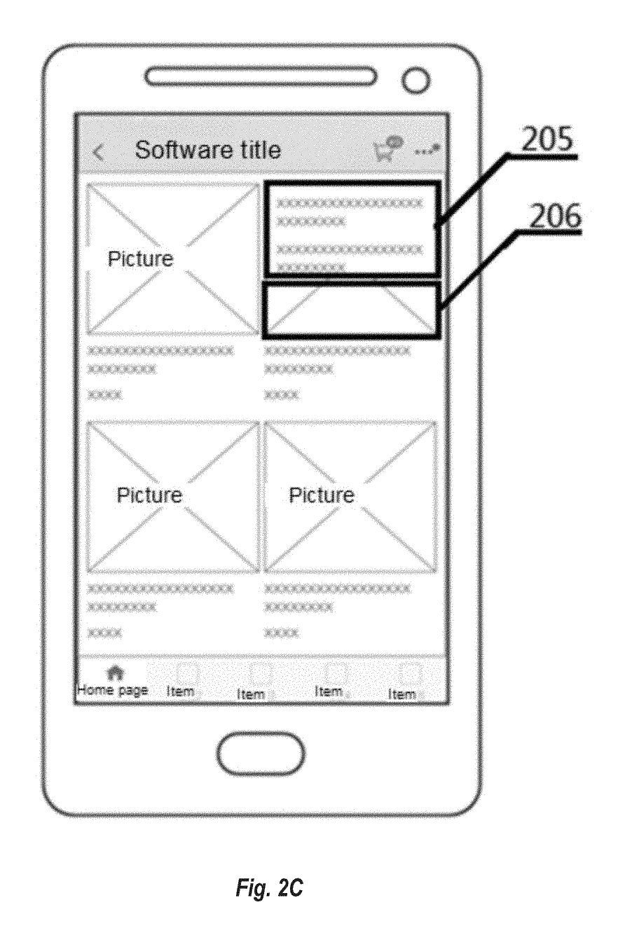

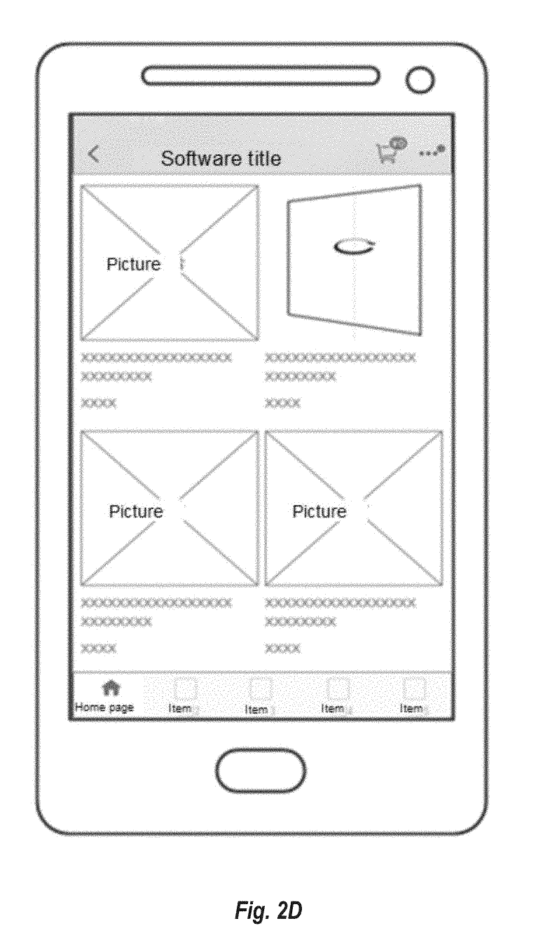

In some embodiments, since an item may be associated with a pre-configured attribute list, a first operation executed on a representative picture of a target item, e.g., pressing and holding the representative picture, e.g., for a few seconds, can be received by the page. Also, at least a part of the content presented at the position of the representative picture can be switched to the associated attribute list in response to the first operation. For example, the page may be presented as shown in FIG. 2A in a default state, including an information presentation position 201, a representative picture 202 of an item presented in the information presentation position, and text description information 203 of the item. After the user presses and holds the representative picture 202 of the item, the attribute list corresponding to the item can be presented at the position of the representative picture 202, and the state after switching can be shown in FIG. 2B, where the position of 204 is the same as the position of 202. That is, in some exemplary embodiments, the representative picture presented at the position is switched to the attribute list. The attribute list can be presented in the same area of the picture, and vice versa. Similar, other types of contents can be switched in the same area as described.

In the above figures, the entire content at the position of the representative picture can be switched to the corresponding attribute list, or, in some embodiments, if the amount of content in the attribute list is small, a part of the content at the position of the representative picture may be switched to the attribute list. For example, as shown in FIG. 2C, 205 is the attribute list presented after switching, and 206 is a part, not blocked by the attribute list, of the representative picture of the corresponding item. That is, in some exemplary embodiments, the attribute list can be presented in a part of the same area of the picture, and vice versa. Similar, other types of contents can be switched in the same part of area as described.

In some embodiments, the text description content in the information presentation position may stay the same before and after switching. That is, only the part of the representative picture may be switched. Further, regardless of the state shown in FIG. 2A or the state shown in FIG. 2B after switching, if the user executes a second operation on the text description content in the information presentation position of an item, the second operation being a click operation, the presentation of a detailed page of the corresponding item can be triggered. The second operation may trigger the switching of the whole page, and when the first operation is executed on the representative picture, only the switching of a part of or the entire content at the position of the target representative picture on the list page may be triggered.

In one embodiment, the attribute list may be presented in various forms, e.g., a picture or a table. Further, when the attribute list is presented, a third operation (for example, pressing and holding or double-clicking) may be executed on the attribute list; and in response to the operation, the content presented at the position of the attribute list may be switched back to the representative picture. During the process of switching from the representative picture to the attribute list and switching from the attribute list back to the representative picture, the content switching process at the corresponding position may be presented in the form of flipping animation. For example, FIG. 2D shows a picture flipping state in the upper right corner, causing switching among various contents in the same area or the same part of area.

As described above, in some embodiments, an attribute list of each item can be directly presented at the position of a representative picture of the item in a list page of the items, to assist the second user to make a purchase decision, and filter out some undesired items without viewing their detailed pages. Therefore, opening too many detailed pages can be avoided, and the browsing efficiency can be improved. From the perspective of system resources, the validity of a presented detailed page can be improved, and the waste of system resources can be reduced.

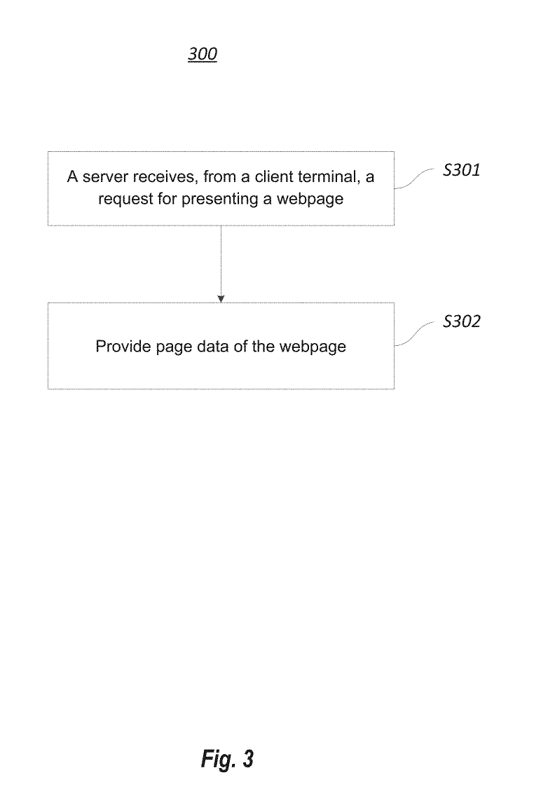

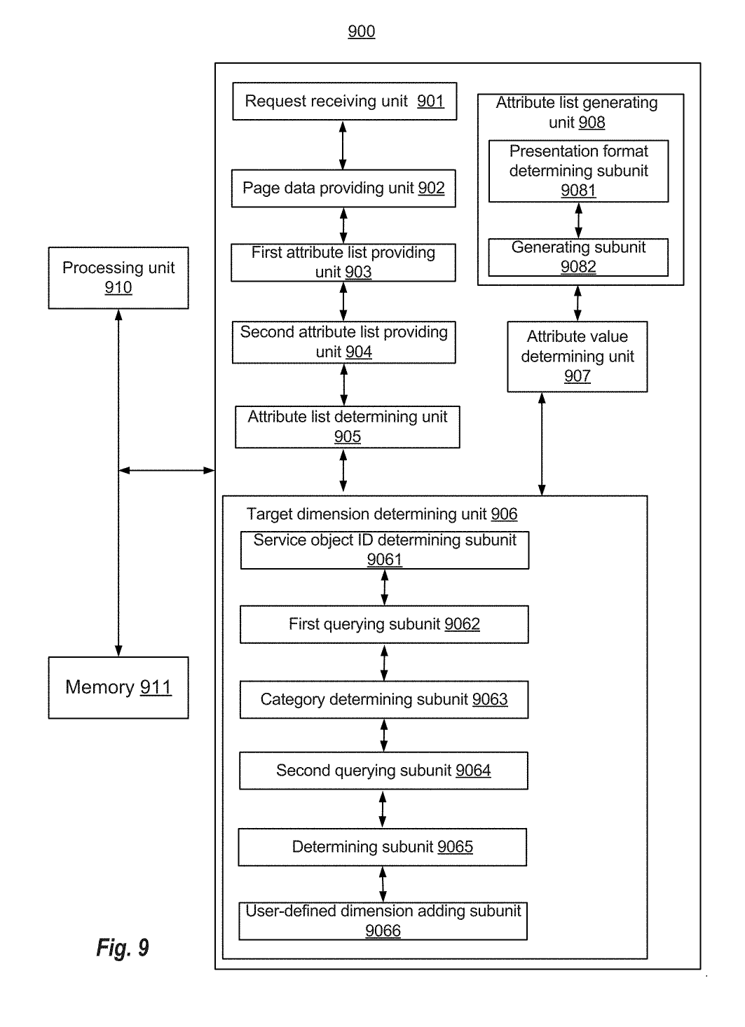

FIG. 3 is a flow diagram illustrating a second method 300 for providing item information, consistent with exemplary embodiments of the present disclosure. The method may be implemented by a specialized server, e.g., apparatus 900 described below with reference to FIG. 9. Method 300 may include the following steps, some of which may be optional.

S301: A server receives, from a client terminal, a request for presenting a webpage.

The page in the step may be, for example, a search result page or a product list page of a store. The page may include multiple information presentation positions presenting digest item information in a default state (e.g., simple information such as a representative picture, price, and quantities of the item).

S302: Provide page data of the webpage, where the page data includes digest information of at least one item, the digest information includes a representative picture of the item, the item is associated with a corresponding attribute list, the attribute list includes attributes of the corresponding item in multiple dimensions and corresponding attribute values, and the page is presented on the client terminal. When a first operation executed on a representative picture of a target item on the page is detected, a part of or the whole content presented at the position of the representative picture may be switched to the associated attribute list.

In some embodiments, the server may provide the attribute list associated with the item in various manners. For one example, when the page data is provided, the attribute list associated with each item on the page can be determined and provided to the client terminal, so that the client terminal can cache the attribute list associated with each item locally. As a result, when the first operation executed on the representative picture of the target item on the page is detected, the temporarily stored information can be queried and a part of or the whole content presented at the position of the representative picture can be switched to the associated attribute list. Thus, the client terminal can respond to the first operation of the user in time, so the switching efficiency is high.

Alternatively, when the page data is provided, the server may not provide the attribute list of each item to the client terminal. After the second user executes the first operation on the representative picture of an item, the client terminal may send a related notification message to the server. The server may receive the notification message and determine and provide the attribute list of the item to the client terminal. The client terminal may use the received attribute list to switch the content presented in the information presentation position. This method can achieve “on-demand services,” to avoid using too many transmission resources for providing page data. Therefore, the loading efficiency of a page in an initial state can be improved.

The attribute list associated with the item may be preset, or generated by the server after receiving the request. In the former method, the server can directly determine the attribute list associated with the item according to a pre-established corresponding relationship between items and attribute lists. That is, the server can pre-establish a corresponding relationship between items and attribute lists, and the method for establishing the corresponding relationship may refer to method 600 and method 700 described below. In the actual application, the corresponding relationship may also be generated through manual establishment. For example, the corresponding relationship may be shown in the following Table 1:

TABLE 1

| IDs of items | Attribute lists |
|---|---|
| 10001 | Attribute list 1 |
| 10002 | Attribute list 2 |
| . . . | . . . |

The attribute list may be saved as a picture, a table, and the like.

In the latter method, the server may automatically generate the attribute list in various manners. In one example, at least one target attribute dimension associated with each item can be determined first. That is, the dimensions' attribute information to be presented can be determined. By querying a pre-established item detailed information database, the attribute value of the item in the corresponding target attribute dimension can be determined. The attribute list can be generated based on the target attribute dimension and the corresponding attribute value.

In some embodiments, the dimensions' attributes to be presented for an item can be determined in various manners. For one example, attribute information in each dimension submitted by the first user for an item may all be presented. In some embodiments, the attribute information submitted by the first user when issuing an item may include attributes in many dimensions. If too much attribute information is presented on the list page, the font and the like of the attribute information may be limited due to the limited presentation space, and the viewing of the attribute information may become inconvenient. Moreover, for a specific item, the second user may only need to pay attention to a part of the attributes. If all the attributes are presented to the second user, the second user may need to select the desired content from the attributes, and the browsing efficiency can be affected.

Therefore, in some embodiments, a database may be pre-established (or another data storage manner may be implemented). The database may store a first corresponding relationship between IDs of items and at least one target attribute dimension, the at least one target attribute dimension being an attribute dimension, of an item, on which the degree of attention paid by the second user satisfies a preset condition. That is, for each item, the attributes dimensions that the second users generally pay attention to can be summarized statistically in advance and stored in the database. By this method, when the attribute item information needs to be presented on the list page, the first corresponding relationship can be queried to determine the dimensions of which the attribute information is to be presented, and the attribute values in these dimensions are read from a detailed database of the item.

For example, the first corresponding relationship can be shown in the following Table 2:

TABLE 2

| | Target attribute |
|---|---|
| IDs of items | dimensions |
| 10001 | Size, color . . . |
| 10002 | Energy, protein . . . |
| . . . | . . . |

The first corresponding relationship may be established by various methods. For one example, the degree of attention paid by the second user on each attribute dimension when the detailed item information is browsed can be determined. Or, during instant messaging with a customer service representative of the first user, the second user may inquire the customer service representative about specific attribute dimension item information. Information related to the attribute dimension of the item can be extracted from the instant messaging records of the second user, and the degree of attention paid by the second user on each attribute dimension and the like can be determined according to the probability of appearance of the attribute dimensions in the instant messaging records.

The degree of attention paid by the second user on each attribute dimension when the detailed item information is browsed can be determined by various methods. For one example, the second user can mark the attribute dimensions that the second user is interested in, the attribute dimensions of the same item that one or more second users pay attention to and mark can be collected, the marking results from the second users can be determined statistically, and the target attribute dimensions associated with the item can be determined.

For example, the second user may be prompted to mark the attribute information and/or attribute dimensions when browsing the detailed page of a specific item. For example, when the server receives a request submitted by the client terminal of the second user for browsing the detailed page of an item, the attributes of the item on the detailed page can be first determined (these attributes may be provided by the first user when issuing the item and may be stored in the detailed information database of the item, and can be presented in a sub-page of “parameters in details” on the detailed page, or in an area of the detailed page). When the detailed information is presented on the detailed page, a first operation option for marking the attributes of each item can be provided. By this method, the second user can mark the attributes that the second user is interested in while browsing the detailed page. Correspondingly, the client terminal of the second user can receive the marking result of the second user and upload the marking result to the server. After receiving the marking results from multiple second users for the same item, the server can statistically determine the attribute dimensions that most of the second users pay attention to based on the marking results.

Alternatively, to avoid interfering with the actual process of browsing a detailed page by the second user, the second user can be prompted to mark the attribute information and/or attribute dimensions after triggering the closing of the detailed page. That is, after receiving a notification message sent by the client terminal of the second user to indicate that the detailed page of an item is closed, the server can extract attributes of the item from the information of the detailed page of the item, and provide an editing interface for marking attributes that the second user is interested in, where the editing interface includes the extracted attribute dimensions and corresponding second marking operation options thereof. By this method, the client terminal of the second user can receive the marking result from the second user through the second marking operation option and upload the marking result to the server. After receiving the marking results from multiple second users for the same item, the server may statistically determine the attributes that most of the second users pay attention to based on the marking results. A third operation option of filling in a user-defined attribute dimension may be further provided on the editing interface. By this method, the second user can submit to the server other attribute dimensions that the second user is interested in, such that the server can adjust, according to the received information, the attribute information that needs to be submitted by the first user when issuing an item.

The above attribute marking methods are optional to the second user. That is, the second user does not have to perform the marking method.

As described above, the corresponding target attribute dimensions can be saved for each item. This method can present customized attribute information of the item in terms of granularity. In actual applications, the following situations may occur. For items in the same category, the target attribute dimensions that the second users generally pay attention to may have strong similarity and may even be the same. Thus, in this case, saving the corresponding target attribute dimension information for each item may lead to a waste of storage space. Moreover, for a newly launched item, if a corresponding relationship of the item is not recorded in the database, it may be impossible to determine the dimension attributes to be presented.

Therefore, according to a preferred embodiment of the present disclosure, a second corresponding relationship between an item category and at least one target attribute may be stored in the database, the at least one target attribute being an attribute on which the degree of attention paid by the second user satisfies a preset condition when the items in the same category are browsed. That is, for the items in each category, the dimensions' attributes that the second users generally pay attention to can be determined statistically in advance and stored in the database. By this method, when the attribute item information needs to be presented on the list page, the category of the item can be first determined, the second corresponding relationship can be queried to determine the dimensions' attribute information to be presented, and the attribute values of the item in these dimensions can be read from a detailed database of the item.

For example, the second corresponding relationship may be shown in the following Table 3:

TABLE 3

| Item categories | Target attribute dimensions |
|---|---|
| Garments | Size, color, style . . . |
| Food | Energy, protein, ingredients . . . |
| Home appliances | Brand, model, size, power consumption . . . |
| Mobile phones | Brand, model, size, CPU, power consumption, |
| | memory . . . |
| Beauty | Benefits, skin type, specification, expiration date, |
| | place of origin . . . |
| Women's shoes | Material, leather feature, heel height, toe style, |
| | fashion elements . . . |
| women's bags | Style, leather material, occasion, style, with or |
| | without an interlayer . . . |
| Hair accessories | Material, inlay material, style . . . |
| . . . | . . . |

For example, the second corresponding relationship may also be established by statistically determining marking information of the second user. Different from the establishment of the first corresponding relationship, after recording the attribute dimension information marked by the second user for each item, the server can determine the category of the items in each record, and collect and statistically determine the records corresponding to the same category.

For the establishment of the second corresponding relationship, since the number of the item categories is limited, the second corresponding relationship may also be specified manually in an actual application.

After at least one target attribute dimension associated with a currently specified item is determined, a pre-established detailed information database of the item can be queried to determine an attribute value of the specified item in the target attribute. The detailed information of the specified item in the detailed information database of the item may be submitted by the first user when issuing the item, and in this step, the attribute values of a part of attributes can be extracted from various types of attribute information submitted by the first user and presented in a list page in subsequent steps.

A specific attribute list can be generated after the target attribute dimensions associated with the item and after the specific attribute values are determined. As described above, the attribute list may be presented as a picture or a table. If the same category corresponds to the same target attribute dimension, since different categories correspond to different target attribute dimensions, the designed attribute presentation formats may also be different, and the attributes may be presented as tables of different structures. In one embodiment, when recording the second corresponding relationship, the server may record attribute presentation formats corresponding to each category. After the attribute information of the current item is determined, the attribute information can be organized according to the presentation format and an attribute list can be generated.

As described above, after the attribute list is generated, the server can provide the attribute list associated with the item to the client terminal, and the client terminal can detect operation of the second user in a page presentation process. The client terminal may present the attribute item information on the page in various manners. For one example, the attribute item information can be directly presented at the position of the representative picture of the item. That is, the information presentation position can present, by default, the digest information of the item including the representative picture of the item. After the second user, for example, double-clicks the information presentation position of the item, the attribute list of the item can be presented at the position of the representative picture in the information presentation position. If the digest information in the information presentation position further includes text description information of the item, this part of the text description information may remain unchanged, and the client terminal may replace the representative picture in the information presentation position with the attribute list, and recombine the attribute list and the text description information into the content presented in the information presentation position.

In some embodiments, a picture flipping animation effect may be provided in the information presentation position. That is, after the second user executes a first operation on the information presentation position, a picture flipping animation effect can be presented, and the attribute list of the item can be presented in the flipped picture. For example, after the second user executes a first operation on an information presentation position, the representative picture in the information presentation position can start flipping, and the attribute list of the item can gradually emerge with the flipping of the picture till the picture is completely flipped. Thus, the attribute list of the item can be presented in the information presentation position.

The attribute information of the item can be presented in the form of a table, and the structure of the table and the attribute/attribute value associated with each cell may be predetermined. Further, for different items or items in different categories, the presented attribute dimensions and structures of the tables and the like may all be different. For example, an item is in the food category, and an attribute list of the item may be shown in the following Table 4:

TABLE 4

| | | | Nutrient reference |
|---|---|---|---|
| Items | Per 100 g | | values % |
| Energy | 325 | kj | 4 |
| Protein | 2.4 | g | 4 |
| Fat | 2.6 | g | 4 |
| Carbohydrate | 10.0 | g | 3 |
| Sodium | 50 | mg | 3 |
| Calcium | 90 | mg | 11 |

In another example, an item is in the garment category, and an attribute list of the item may be shown in the following Table 5:

TABLE 5
Material composition: 79.1% of viscose fiber
Thickness: thin
Collar type: low round collar

| Size | shoulder | bust | length |
|---|---|---|---|
| L | 38 | 94 | 81 |
| M | 37 | 93 | 80 |
| XL | 39 | 95 | 82 |

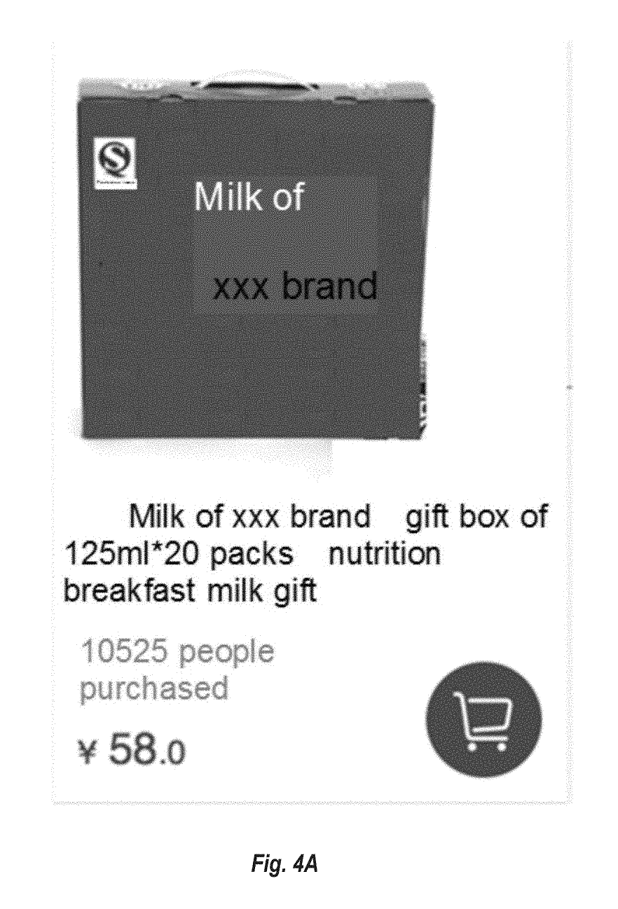

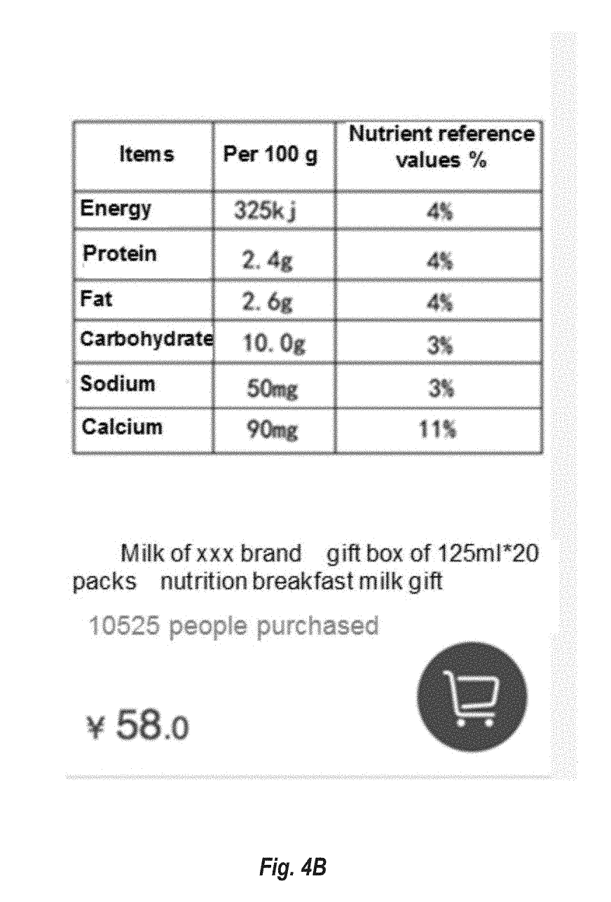

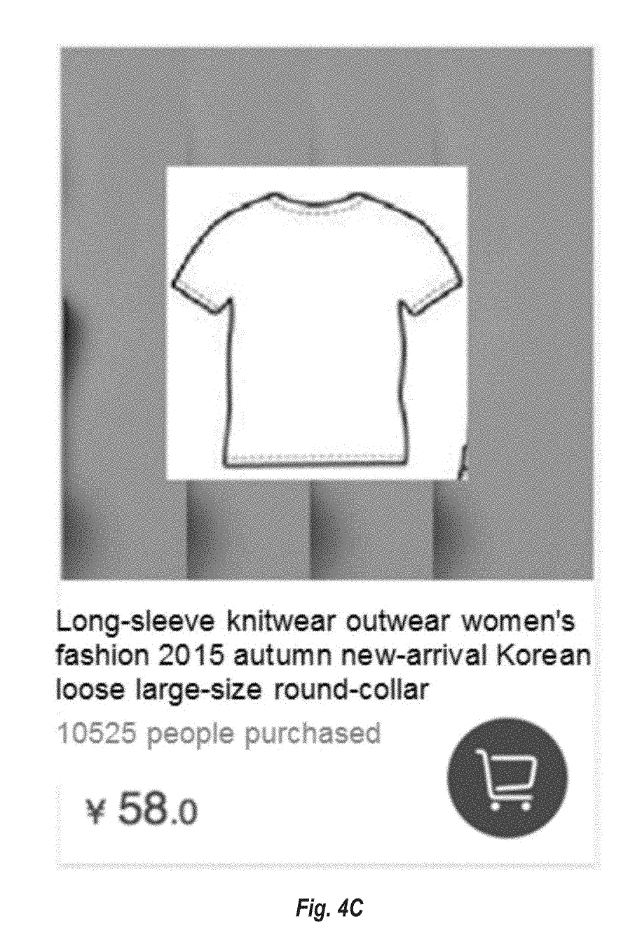

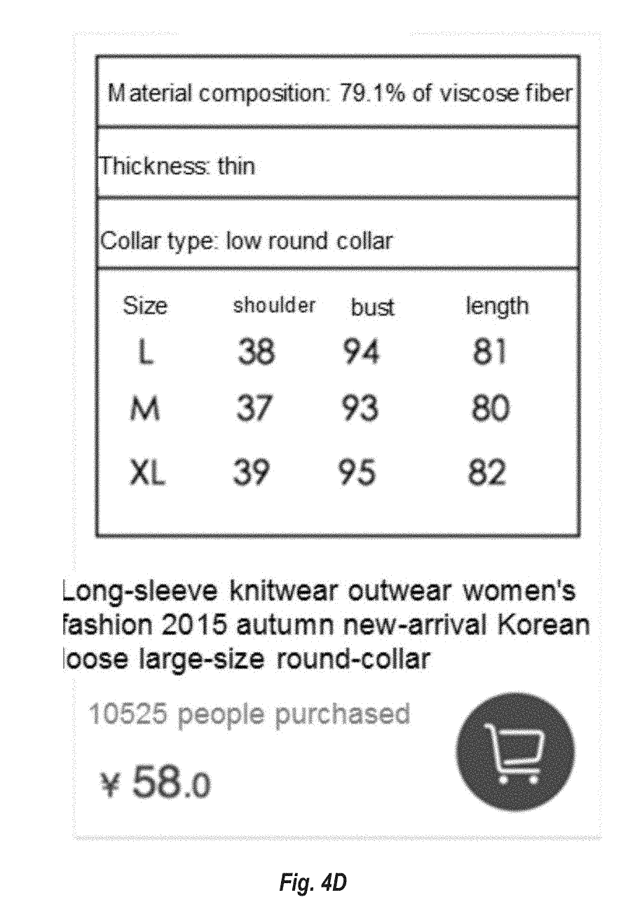

The server may provide the attribute list in the format of a picture or a table, and the client terminal may present the attribute list in the corresponding information presentation position. In the first example above, if the digest information of the item presented in the information presentation position is that shown in FIG. 4A, the content presented in the information presentation position after flipping may be shown in FIG. 4B. In the second example above, if the digest information of the item presented in the information presentation position is that shown in FIG. 4C, the content presented in the information presentation position after flipping may be shown in FIG. 4D.

As described above, according to the embodiments of the present disclosure, attribute information of each item can be directly presented in a list page of the items, so the second user can use the attribute information to make a purchase decision, e.g., filter out some undesired items without viewing detailed pages of the items. Therefore, it may be unnecessary to open too many detailed pages, and the browsing efficiency can be improved. Further, from the perspective of system resources, the validity of a presented detailed page can be improved, and the waste of system resources can be reduced.

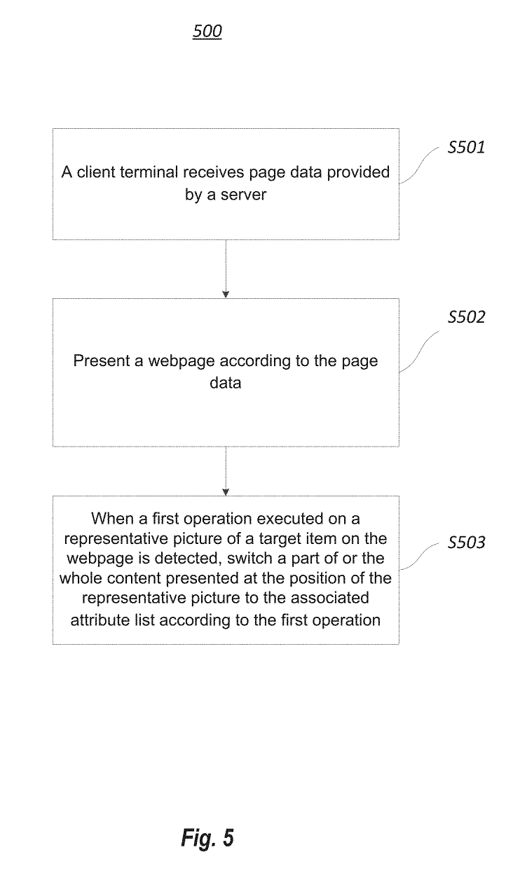

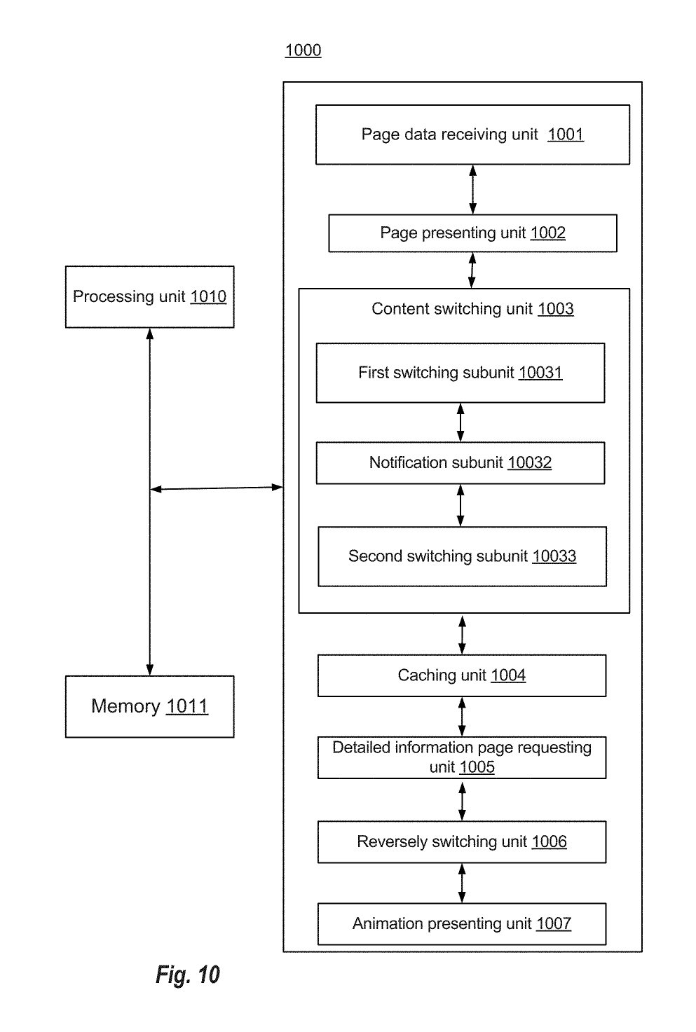

A method for providing item information from the perspective of a server is described above, and FIG. 5 may illustrate such method from the perspective of a client terminal of a second user. FIG. 5 is a flow diagram illustrating a method 500 for providing item information, consistent with exemplary embodiments of the present disclosure. The method may be implemented by a client terminal of a second user, e.g., apparatus 1000 described below with reference to FIG. 10. Method 500 may include the following steps, some of which may be optional.

S501: A client terminal receives page data provided by a server, where the page data includes digest information of at least one item, the digest information includes a representative picture of the item, the item is associated with a corresponding attribute list, and the attribute list includes attributes of the associated item in multiple dimensions and corresponding attribute values.

S502: Present a webpage according to the page data.

S503: When a first operation executed on a representative picture of a target item on the webpage is detected, switch a part of or the whole content presented at the position of the representative picture to the associated attribute list according to the first operation.

In some embodiments, if the server provides the information of the attribute list associated with each item on the page when providing the page data, the client terminal can cache locally the information of the attribute list associated with each item on the page. When the first operation executed on the representative picture of the target item on the target page is detected, the information of the attribute list associated with the target item can be extracted from the temporarily stored information, and a part of or the whole content presented at the position of the representative picture can be switched to the cached attribute list.

Alternatively, when the first operation executed on the representative picture of the target item on the target page is detected, a notification message can be sent to the server, so that the server can determine the attribute list associated with the target item and return the attribute list. According to the received attribute list associated with the target item, a part of or the whole content presented at the position of the representative picture can be switched to the associated attribute list.

The page may include an item list page for presenting digest information of multiple items. The item list page may include multiple information presentation positions each presenting the digest item information. The digest information may include a representative picture and text description information. For example, during switching, the representative picture can be replaced with the associated attribute list, and the attribute list and the text description information can be combined into the content presented in the corresponding information presentation position.

In one embodiment, the text description information of the item may be associated with the corresponding detailed information page, and therefore, the client terminal may request the server for the detailed information page of the item associated with the target presentation position in response to a second operation executed on the text description information in the target information presentation position.

Further, when the attribute list is presented, the content presented at the position of the attribute list can be switched back to the representative picture in response to a third operation executed on the attribute list. During switching, the content switching process at the corresponding position may be presented in the form of flipping animation.

Details of similar steps among various methods are not repeated here.

A method for determining an attribute list of an item is disclosed below. That is, in order to easily determine attributes in which dimensions of an item that are to be provided in a list page, an attribute list of the item can be pre-established, and the item can be associated with the attribute list. By this method, when attribute item information needs to be presented on the list page, the association relationship can be queried to determine the associated attribute list.

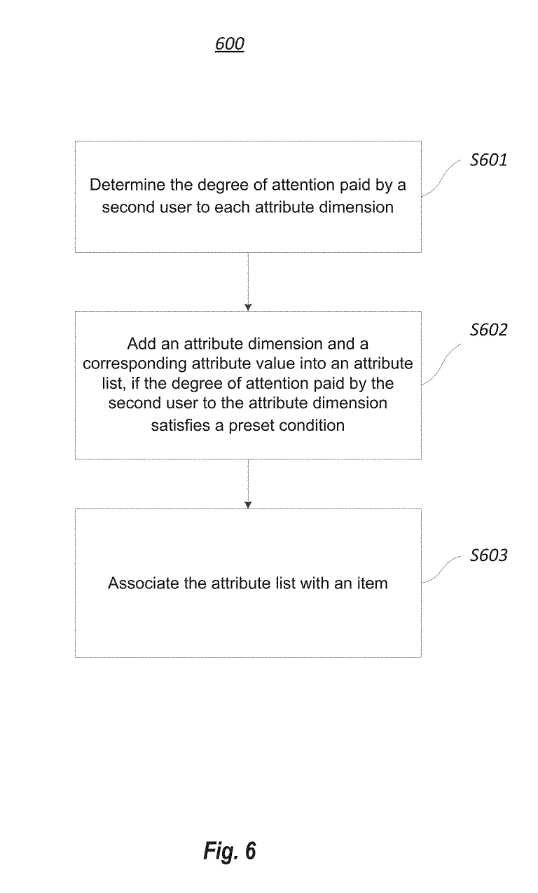

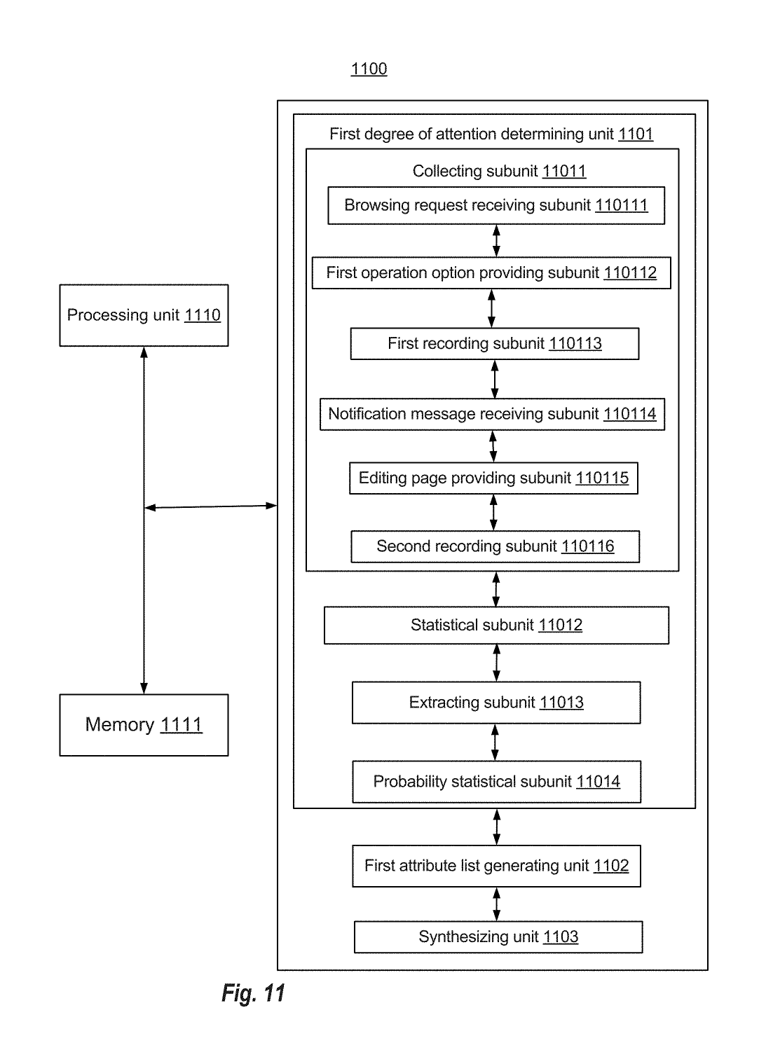

FIG. 6 is a flow diagram illustrating a method 600 for determining an attribute list of an item, consistent with exemplary embodiments of the present disclosure. Referring to FIG. 6, a server may execute an operation of the following steps on a part of or all attribute dimensions of an item according to the method. Method 600 may be implemented by apparatus 1100 described below with reference to FIG. 11. Method 600 may include the following steps, some of which may be optional.

S601: Determine the degree of attention paid by a second user to each attribute dimension.

S602: Add an attribute dimension and a corresponding attribute value into an attribute list, if the degree of attention paid by the second user to the attribute dimension satisfies a preset condition.

S603: Associate the attribute list with the item.

In one embodiment, the attribute list of the item and pre-configured text description information may be synthesized into a picture, and the picture can be associated with the item.

When the degree of attention paid by the second user to each attribute dimension is determined, the degree of attention paid by the second user to each attribute dimension when the detailed information of the item is browsed can be determined. For example, the attribute dimensions of information of the same item that at least one second user pays attention to and marks can be collected. By statistically determining the marking results from the second users, the degree of attention paid by the second users to each attribute dimension can be determined.

For example, to collect the attribute dimensions of the information of the same item that at least one second user pays attention to and marks, after a request submitted by a client terminal of a second user for browsing a detailed page of an item is received, attribute dimensions of the item on the detailed page may be determined. A first operation option for marking the attribute dimensions of each item can be provided on the detailed page, and the client terminal of the second user can receive the marking result from the second user through the first operation option. After receiving the marking result submitted by the client terminal of the second user, a corresponding relationship between the item and the marking result from the second user can be recorded for a statistical operation.

Alternatively, after receiving a notification message submitted by a client terminal of a second user which indicates that the detailed page of an item is closed, attribute dimensions of the item can be extracted from the information of the detailed page of the item, and an editing interface for marking attributes that the second user is interested in can be provided. The editing interface may include the extracted attribute dimensions and corresponding second marking operation options thereof. By this method, the client terminal of the second user can receive the marking result from the second user through the second marking operation option. After the marking result submitted by the client terminal of the second user is received, a corresponding relationship between the item and the marking result of the second user can be recorded for a statistical operation.

Further, information related to the attribute dimensions of the item may be extracted from instant messaging records of the second user, and the degree of attention paid by the second user to each attribute dimension can be determined according to the probability of appearance of the attribute dimensions in the instant messaging records.

The implementation and information storage manner and the like in the above embodiment are not repeated here, and reference can be made to the earlier embodiments.

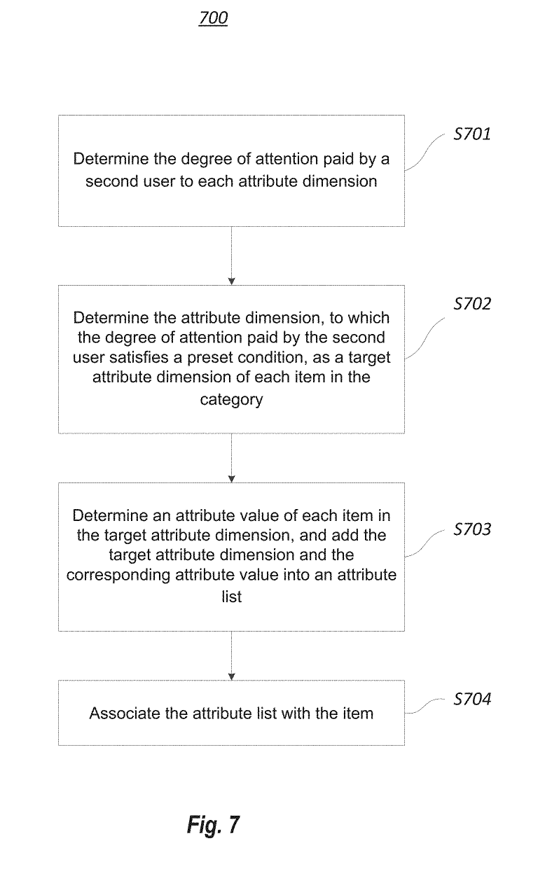

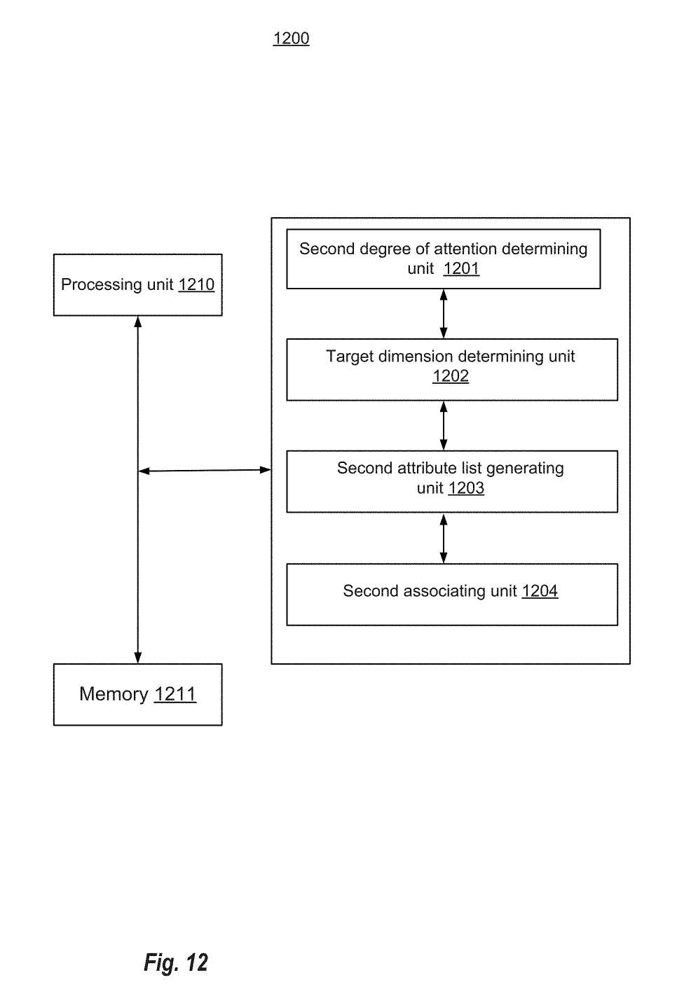

FIG. 7 is a flow diagram illustrating a method 700 for determining an attribute list of an item, consistent with exemplary embodiments of the present disclosure. Method 700 may be implemented by apparatus 1200 described below with reference to FIG. 12. Method 700 may include the following steps, some of which may be optional. The following operations may be executed on a part of or all attribute dimensions of each item in a category according to the method.

S701: Determine the degree of attention paid by a second user to each attribute dimension.

S702: Determine the attribute dimension, to which the degree of attention paid by the second user satisfies a preset condition, as a target attribute dimension of each item in the category.

S703: Determine an attribute value of each item in the target attribute dimension, and add the target attribute dimension and the corresponding attribute value into an attribute list.

S704: Associate the attribute list with the item.

According to the embodiments of the present disclosure, an attribute list of each item can be directly presented in a list page of the items, so the second user can use the attribute lists to make a purchase decision, and especially filter out some undesired items without having to view detailed pages of the items. Therefore, opening too many detailed pages can be avoided, and the browsing efficiency can be improved. From the perspective of system resources, the validity of a presented detailed page can be improved, and the waste of system resources can be reduced.

FIG. 8 is a block diagram illustrating a first apparatus 800 for providing item information, consistent with exemplary embodiments of the present disclosure. Apparatus 800 may include the following components, some of which may be optional. The components in FIG. 8 may be arranged in another order. Apparatus 800 may include, for example, a processing unit 810 and a memory 811. Memory 811 may be a non-transitory computer-readable storage medium storing instructions that, when executed by processing unit 810, cause one or more components of apparatus 800 to perform the steps and methods described in this disclosure. Apparatus 800 may include functional modules implemented by the processing unit 810 and the memory 811, including, e.g., a page providing unit 801, a content switching unit 802, a detailed page providing unit 803, a reversely switching unit 804, and an animation effect presentation unit 805. The page providing unit 801, the content switching unit 802, the detailed page providing unit 803, the reversely switching unit 804, and/or the animation effect presentation unit 805 refer to or correspond to blocks of software code stored on memory 811. The processing unit 810 can execute the blocks of software code and perform the functions corresponding to the functional modules.

Referring to FIG. 8, the apparatus 800 may include:

a page providing unit 801 configured to provide a webpage, where the webpage includes digest information of at least one item, the digest information includes a representative picture of the item, the item is associated with a corresponding attribute list, and the attribute list includes attributes of the associated item in multiple dimensions and corresponding attribute values; and

a content switching unit 802 configured to, in response to a first operation executed on a representative picture of a target item, switch a part of or the whole content presented at the position of the representative picture to the associated attribute list.

The page may include an item list page for presenting multiple items, the item list page may include multiple information presentation positions, and each information presentation position may present the digest item information.

The digest information may also include text description information of the item, and the content switching unit 802 may be further configured to replace the representative picture with the associated attribute list, and combine the attribute list and the text description information into the content presented in the corresponding information presentation position.

The digest information may further include the text description information of the item, the text description information associated with the corresponding detailed information page, and the apparatus 800 may further include:

a detailed page providing unit 803 configured to, in response to a second operation executed on the text description information in a target information presentation position, provide a detailed information page of the item associated with the target presentation position.

The content switching unit 802 may be further configured to present the associated attribute list in the form of a picture or a table.

In some embodiments, the apparatus 800 may further include:

a reversely switching unit 804 configured to, when the attribute list is presented, switch the content presented at the position of the attribute list back to the representative picture in response to a third operation executed on the attribute list.

The apparatus 800 may further include an animation effect presenting unit 805 configured to, present the content switching process at the corresponding position in the form of flipping animation.

FIG. 9 is a block diagram illustrating an apparatus/system 900 for providing item information, consistent with exemplary embodiments of the present disclosure. Apparatus 900 may include the following components, some of which may be optional. The components in FIG. 9 may be arranged in another order. Apparatus 900 may include, for example, a processing unit 910 and a memory 911. Memory 911 may be a non-transitory computer-readable storage medium storing instructions that, when executed by processing unit 910, cause one or more components of apparatus 900 to perform the steps and methods described in this disclosure. Apparatus 900 may include functional modules implemented by the processing unit 810 and the memory 811, including, e.g., a request receiving unit 901, a page data providing unit 902, a first attribute list providing unit 903, a second attribute list providing unit 904, an attribute list determining unit 905, a target dimension determining unit 906, an attribute value determining unit 907, and an attribute list generating unit 908. The request receiving unit 901, the page data providing unit 902, the first attribute list providing unit 903, the second attribute list providing unit 904, the attribute list determining unit 905, the target dimension determining unit 906, the attribute value determining unit 907, and/or the attribute list generating unit 908 refer to or correspond to blocks of software code stored on memory 911. The processing unit 910 can execute the blocks of software code and perform the functions corresponding to the functional modules.

Referring to FIG. 9, the apparatus 900 may include:

a request receiving unit 901 configured to receive, from a client terminal, a request for presenting a webpage; and

a page data providing unit 902 configured to provide page data of the webpage, where the page data includes digest information of at least one item, the digest information includes a representative picture of the item, the item is associated with a corresponding attribute list, the attribute list includes attributes of the corresponding item in multiple dimensions and corresponding attribute values, and the page is presented on the client terminal. When a first operation executed on a representative picture of a target item on the page is detected, the page data providing unit 902 is further configured to switch a part of or the whole content presented at the position of the representative picture to the associated attribute list.

In one embodiment, the apparatus 900 may further include a first attribute list providing unit 903 configured to, when the page data of the page is provided, further determine the attribute list associated with each item on the page and provide the attribute list to the client terminal, so that the client terminal temporarily stores the attribute list locally, and when the first operation executed on the representative picture of the target item on the page is detected, queries the temporarily stored information and switches a part of or the whole content presented at the position of the representative picture to the associated attribute list.

Or, the apparatus 900 may further include a second attribute list providing unit 904 configured to, when receiving a notification message sent by the client terminal to indicate that the first operation is executed on the representative picture of the target item on the page, determine the attribute list associated with the target item and provide the attribute list to the client terminal, so that the client terminal switches a part of or the whole content presented at the position of the representative picture of the target item to the associated attribute list.

The apparatus 900 may further include an attribute list determining unit 905 configured to determine the attribute list associated with the item according to a pre-established corresponding relationship between items and attribute lists.

The apparatus 900 may further include:

a target dimension determining unit 906 configured to determine multiple target attribute dimensions associated with the item;

an attribute value determining unit 907 configured to query a pre-established detailed information database of the item, and determine attribute values of the item in the corresponding target attribute dimensions; and

an attribute list generating unit 908 configured to generate the attribute list based on the target attribute dimensions and the corresponding attribute values.

The target dimension determining unit 906 may include:

an item ID determining subunit 9061 configured to determine an ID of the item; and

a first querying subunit 9062 configured to query a pre-established first corresponding relationship, and determine the multiple target attribute dimensions associated with the item, where the first corresponding relationship records association relationships between IDs of items and attribute dimensions.

Or, the target dimension determining unit 906 may include:

a category determining subunit 9063 configured to determine a target category of the item; and

a second querying subunit 9064 configured to query a pre-established second corresponding relationship, determine multiple target attribute dimensions associated with the target category, and determine the multiple target attribute dimensions as multiple target attribute dimensions associated with the item, where the second corresponding relationship records association relationships between categories and attribute dimensions.

The second corresponding relationship may further store information of an attribute list presentation format of each category, and the attribute list generating unit 908 may include:

a presentation format determining subunit 9081 configured to determine an attribute list presentation format of each item according to the category of each item; and

a generating subunit 9082 configured to organize the attribute values of the item in the target attribute dimensions according to the information of the attribute list presentation format, and generate the attribute list.

Or, the target dimension determining unit 906 may further include:

a determining subunit 9065 configured to determine whether the detailed information database of the item includes information of a user-defined attribute provided by a first user for the item; and

a user-defined dimension adding subunit 9066 configured to, if the detailed information database of the item includes information of the user-defined attribute, add the dimension of the user-defined attribute into the target attribute dimensions.

FIG. 10 is a block diagram illustrating an apparatus 1000 for providing item information, consistent with exemplary embodiments of the present disclosure. The apparatus 1000 may be a client terminal. Apparatus 1000 may include the following components, some of which may be optional. The components in FIG. 10 may be arranged in another order. Apparatus 1000 may include, for example, a processing unit 1010 and a memory 1011. Memory 1011 may be a non-transitory computer-readable storage medium storing instructions that, when executed by processing unit 1010, cause one or more components of apparatus 1000 to perform the steps and methods described in this disclosure. Apparatus 1000 may include functional modules implemented by the processing unit 1010 and the memory 1011, including, e.g., a page data receiving unit 1001, a page presenting unit 1002, a content switching unit 1003, a caching unit 1004, a detailed information page requesting unit 1005, a reversely switching unit 1006, and/or an animation presentation unit 1007. The page data receiving unit 1001, the page presenting unit 1002, the content switching unit 1003, the caching unit 1004, the detailed information page requesting unit 1005, the reversely switching unit 1006, and the animation presentation unit 1007 refer to or correspond to blocks of software code stored on memory 1011. The processing unit 1010 can execute the blocks of software code and perform the functions corresponding to the functional modules.

Referring to FIG. 10, the apparatus 1000 may include:

a page data receiving unit 1001 configured to receive page data provided by a server, where the page data includes digest information of at least one item, the digest information includes a representative picture of the item, the item is associated with a corresponding attribute list, and the attribute list includes attributes of the associated item in multiple dimensions and corresponding attribute values;

a page presenting unit 1002 configured to present the page according to the page data; and

a content switching unit 1003 configured to, when a first operation executed on a representative picture of a target item on a target page is detected, switch a part of or the whole content presented at the position of the representative picture to the associated attribute list.

When providing the page data, the server may also provide information of the attribute list associated with each item on the page.

The apparatus 1000 may further include a caching unit 1004 configured to cache locally the information of the attribute list associated with each item on the page.

The content switching unit 1003 may include a first switching subunit 10031 configured to, when the first operation executed on the representative picture of the target item on the target page is detected, extract, from the temporarily stored information, the information of the attribute list associated with the target item, and switch a part of or the whole content presented at the position of the representative picture to the associated attribute list.

The content switching unit 1003 may further include:

a notification subunit 10032 configured to, when the first operation executed on the representative picture of the target item on the target page is detected, send a notification message to the server, so that the server determines the attribute list associated with the target item and returns the attribute list; and

a second switching subunit 10033 configured to, according to the received attribute list associated with the target item, switch a part of or the whole content presented at the position of the representative picture to the associated attribute list.

The page may include an item list page for presenting digest information of multiple items, the item list page may include multiple information presentation positions, each information presentation position may present the digest item information, and the digest information may include the representative picture and text description information.

The content switching unit 1003 may be configured to replace the representative picture with the associated attribute list, and combine the attribute list and the text description information into the content presented in the corresponding information presentation position.

The text description information of the item may be associated with the corresponding detailed information page, and the apparatus 1000 may further include:

a detailed information page requesting unit 1005 configured to, in response to a second operation executed on the text description information in a target information presentation position, request the server for a detailed information page of the item associated with the target presentation position.

The apparatus 1000 may further include:

a reversely switching unit 1006 configured to, when the attribute list is presented, switch the content presented at the position of the attribute list back to the representative picture in response to a third operation executed on the attribute list; and

an animation presenting unit 1007 configured to present the content switching process at the corresponding position in the form of flipping animation.

FIG. 11 is a block diagram illustrating an apparatus 1100 for determining an attribute list of an item, consistent with exemplary embodiments of the present disclosure. Apparatus 1100 may include the following components, some of which may be optional. The components in FIG. 11 may be arranged in another order. Apparatus 1100 may include, for example, a processing unit 1110 and a memory 1111. Memory 1111 may be a non-transitory computer-readable storage medium storing instructions that, when executed by processing unit 1110, cause one or more components of apparatus 1100 to perform the steps and methods described in this disclosure. Apparatus 1100 may include functional modules implemented by the processing unit 1110 and the memory 1111, including, e.g., a first degree of attention determining unit 1101, a first attribute list generating unit 1102, and/or a synthesizing unit 1103. The first degree of attention determining unit 1101, the first attribute list generating unit 1102, and the synthesizing unit 1103 refer to or correspond to blocks of software code stored on memory 1111. The processing unit 1110 can execute the blocks of software code and perform the functions corresponding to the functional modules.

Referring to FIG. 11, the apparatus 1100 may include:

a first degree of attention determining unit 1101 configured to determine the degree of attention paid by a second user to each attribute dimension among a part of or all attribute dimensions of an item;

a first attribute list generating unit 1102 configured to add the attribute dimension, to which the degree of attention paid by the second user satisfies a preset condition, and a corresponding attribute value into an attribute list; and

a first associating unit 1103 configured to associate the attribute list with the item.

In one embodiment, the apparatus 1100 may further include a synthesizing unit 1103 configured to synthesize the attribute list of the item and pre-configured text description information into a picture, and associate the picture with the item.

The first degree of attention determining unit 1101 may be further configured to determine the degree of attention paid by the second user to each attribute dimension when the detailed information of the item is browsed.

The first degree of attention determining unit 1101 may include:

a collecting subunit 11011 configured to collect the attribute dimensions of information of the same item that at least one second user pays attention to and marks; and

a statistical subunit 11012 configured to statistically determine the marking results from the second users, and determine the degree of attention paid by the second users to each attribute dimension.

The collecting subunit 11011 may include:

a browsing request receiving subunit 110111 configured to, when receiving a request submitted by the client terminal of a second user for browsing the detailed page of an item, determine the attribute dimensions of the item on the detailed page;

a first operation option providing subunit 110112 configured to provide a first operation option for marking the attribute dimensions of each item on the detailed page, so that the client terminal of the second user receives the marking result from the second user through the first operation option; and

a first recording subunit 110113 configured to, after receiving the marking result submitted by the client terminal of the second user, record a corresponding relationship between the item and the marking result from the second user for a statistical operation.

Or, the collecting subunit 11011 may include:

a notification message receiving subunit 110114 configured to, after receiving a notification message submitted by a client terminal of a second user to indicate that the detailed page of an item is closed, extract attribute dimensions of the item from the information of the detailed page of the item; and

an editing page providing subunit 110115 configured to provide an editing interface for marking attributes that the second user is interested in, where the editing interface includes the extracted attribute dimensions and corresponding second marking operation options thereof, so that the client terminal of the second user receives the marking result from the second user through the second marking operation option; and

a second recording subunit 110116 configured to, after receiving the marking result submitted by the client terminal of the second user, record a corresponding relationship between the item and the marking result of the second user for a statistical operation.

The first degree of attention determining unit 1011 may further include:

an extracting subunit 11013 configured to extract information related to the attribute dimensions of the item from instant messaging records of the second user; and

a probability statistical subunit 11014 configured to determine the degree of attention paid by the second user on each attribute dimension according to the probability of appearance of the attribute dimensions in the instant messaging records.

FIG. 12 is a block diagram illustrating an apparatus 1200 for determining an attribute list of an item, consistent with exemplary embodiments of the present disclosure. Apparatus 1200 may include the following components, some of which may be optional. The components in FIG. 12 may be arranged in another order. Apparatus 1200 may include, for example, a processing unit 1210 and a memory 1211. Memory 1211 may be a non-transitory computer-readable storage medium storing instructions that, when executed by processing unit 1210, cause one or more components of apparatus 1200 to perform the steps and methods described in this disclosure. Apparatus 1200 may include functional modules implemented by the processing unit 1210 and the memory 1211, including, e.g., a second degree of attention determining unit 1201, a target dimension determining unit 1202, a second attribute list generating unit 1203, and/or a second associating unit 1204. The second degree of attention determining unit 1201, the target dimension determining unit 1202, the second attribute list generating unit 1203, and the second associating unit 1204 refer to or correspond to blocks of software code stored on memory 1211. The processing unit 1210 can execute the blocks of software code and perform the functions corresponding to the functional modules.

Referring to FIG. 12, the apparatus 1200 may include:

a second degree of attention determining unit 1201 configured to determine the degree of attention paid by a second user to each attribute dimension among a part of or all attribute dimensions of each item in a category;

a target dimension determining unit 1202 configured to determine the attribute dimension on which the degree of attention paid by the second user satisfies a preset condition as a target attribute dimension of each item in the category;

a second attribute list generating unit 1203 configured to determine an attribute value of each item in the target attribute dimension, and add the target attribute dimension and the corresponding attribute value into an attribute list; and

a second associating unit 1204 configured to associate the attribute list with the item.

Through the above description of the embodiments, it is apparent to persons skilled in the art that the present disclosure may be accomplished by software on a necessary universal hardware platform. Therefore, the technical solutions of the present disclosure or the part that makes contributions to the prior art can be substantially embodied in the form of a software product. The computer software product may be stored in a storage medium such as a ROM/RAM, a magnetic disk, or an optical disc, and contain several instructions to instruct a computer device (for example, a personal computer, a server, or a network device) to perform the methods described in the embodiments of the present disclosure or in some parts of the embodiments of the present disclosure.

All the embodiments in the specification are described in a progressive manner, reference may be made to each other for the same or similar parts of the embodiments, and each embodiment focuses on the differences from the other embodiments. Especially, as the system or system embodiment is substantially similar to the method embodiment, the system or system embodiment is described simply, and reference may be made to the corresponding description in the method embodiment for the related parts. The system or system embodiment is merely exemplary, units described as separate components may or may not be physically separated, and components shown as units may or may not be physical units, that is, may be integrated or distributed to a plurality of network units. Some or all of the modules may be selected to achieve the objective of the solution of the embodiment according to actual demands. Persons of ordinary skill in the art can understand and implement the present application without creative efforts.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for providing item information. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method, implemented by a server, for providing item information, comprising:
providing a webpage, wherein:
the webpage comprises digest information of at least one item,
the digest information comprises a representative picture of the item,
the item is associated with a corresponding attribute list, and
the attribute list comprises attributes of the associated item; and
in response to a first operation executed on the representative picture, switching at least a part of contents presented at a position of the representative picture to the associated attribute list.

2. The method according to claim 1, wherein:
the webpage comprises an item list page presenting the at least one item;
the item list page comprises multiple information presentation positions; and
each information presentation position presents the digest information of the item.

3. The method according to claim 2, wherein:
the digest information further comprises text description information of the item; and
switching at least the part of the contents presented at the position of the representative picture to the associated attribute list comprises:
replacing the representative picture with the associated attribute list, and
combining the attribute list and the text description information to present at the corresponding information presentation position.

4. The method according to claim 2, wherein the digest information further comprises text description information of the item, the text description information being associated with a corresponding detailed information page; and
the method further comprising, in response to a second operation executed on the text description information in a target information presentation position, providing a detailed information page of the item associated with the target presentation position.

5. The method according to claim 1, wherein switching at least the part of the contents presented at the position of the representative picture to the associated attribute list comprises presenting the associated attribute list as a picture.

6. The method according to claim 1, wherein switching at least the part of the contents presented at the position of the representative picture to the associated attribute list comprises presenting the associated attribute list as a table.

7. The method according to claim 1, further comprising switching contents associated with the attribute list back to the representative picture in response to a third operation executed on the attribute list.

8. A method for providing item information, comprising:
receiving, by a server from a client terminal, a request for presenting a webpage; and
providing page data of the webpage, wherein:
the page data comprises digest information of at least one item,
the digest information comprises a representative picture of the item,
the item is associated with a corresponding attribute list,
the attribute list comprises attributes of the corresponding item in multiple dimensions and corresponding attribute values, and
the webpage is presented on the client terminal; and
in response to a first operation executed on a representative picture of a target item of the at least one item on the webpage, switching at least a part of contents presented at the position of the representative picture to the associated attribute list.

9. The method according to claim 8, comprising:
determining the attribute list associated with each item on the webpage; and
providing the attribute list to the client terminal, causing the client terminal to cache the attribute list locally, query the cached information in response to the first operation, and switch at least the part of the contents to the cached attribute list.

10. The method according to claim 8, comprising, according to a notification message sent by the client terminal to indicate that the first operation is executed on the representative picture of the target item on the webpage, determining an attribute list associated with the target item and providing the attribute list to the client terminal, causing the client terminal to switch at least the part of the contents to the attribute list associated with the target item.

11. The method according to claim 9, wherein determining the attribute list associated with the item is based on a pre-established corresponding relationship between the at least one item and at least one attribute list.

12. The method according to claim 9, wherein determining the attribute list associated with the item comprises:
determining multiple target attribute dimensions associated with the item;
querying a pre-established item detailed information database to determine attribute values of the item in the corresponding target attribute dimensions; and
generating the attribute list based on the target attribute dimensions and the corresponding attribute values.

13. The method according to claim 12, wherein determining the multiple target attribute dimensions associated with the item comprises:
determining an ID of the item; and
querying a pre-established first corresponding relationship to determine the multiple target attribute dimensions associated with the item, wherein the first corresponding relationship records association relationships between IDs of items and attribute dimensions.

14. The method according to claim 12, wherein determining the multiple target attribute dimensions associated with the item comprises:
determining a target category of the item; and
querying a pre-established second corresponding relationship to determine multiple target attribute dimensions associated with the target category as associated with the item, wherein the second corresponding relationship records association relationships between categories and attribute dimensions.

15. The method according to claim 14, wherein:
the second corresponding relationship further stores information of an attribute list presentation format of each category; and
generating the attribute list based on the target attribute dimensions and the corresponding attribute values comprises:
determining an attribute list presentation format of each item according to the category of the item, and
organizing the attribute values of the item in the target attribute dimensions according to the attribute list presentation format to generate the attribute list.

16. The method according to claim 12, wherein determining the multiple target attribute dimensions associated with the item comprises:
determining whether the detailed information database of the item comprises information of a user-defined attribute provided by a first user for the item; and
if the detailed information database comprises the information of the user-defined attribute, adding a dimension of the user-defined attribute into the target attribute dimensions.

17. A method for providing item information, comprising:
receiving, by a client terminal, page data provided by a server, wherein:
the page data comprises digest information of at least one item,
the digest information comprises a representative picture of the item,
the item is associated with a corresponding attribute list, and
the attribute list comprises attributes of the associated item in multiple dimensions and corresponding attribute values;
presenting a webpage according to the page data; and
in response to a first operation executed on a representative picture of a target item of the at least one item on the webpage, switching at least a part of contents presented at the position of the representative picture to the associated attribute list.

18. The method according to claim 17, further comprising locally caching information of the attribute list associated with each item on the webpage and provided by the server, wherein the associated attribute list comprises the information of the attribute list associated with the target item extracted from the cache.

19. The method according to claim 17, wherein switching at least the part of the contents presented at the position of the representative picture to the associated attribute list comprises:
sending a notification message to the server, causing the server to determine the attribute list associated with the target item and return the attribute list; and
according to the returned attribute list associated with the target item, switching at least the part of the contents presented at the position of the representative picture to the associated attribute list.

20. The method according to claim 18, wherein:
the webpage comprises an item list page presenting the at least one item;
the item list page comprises multiple information presentation positions;
each information presentation position presents the digest information of the item;
the digest information further comprises the representative picture and text description information of the item; and
switching at least the part of the contents presented at the position of the representative picture to the associated attribute list comprises:
replacing the representative picture with the associated attribute list, and
combining the attribute list and the text description information to present at the corresponding information presentation position.
